(19) United States
(12) Patent Application Publication
(10) Pub. No.: US 2010/0287084 A1
(43) Pub. Date: Nov. 11, 2010

(54) APPARATUS AND METHODS FOR ANALYSING SECURITIES DATA

(75) Inventors: Alice Roberts, Bangkok (TH); Jutaporn Charin, Pathumthani (TH); Arintra Punyayuttakan, Bangkok (TH); Alongkorn Namvong, Bangkok (TH); Boonchu Preechathammarach, Bangkok (TH); Jakrawoot Wongsa, Bangrak (TH); Navapat Jabang, Nonthaburi (TH)

Correspondence Address: FOLEY AND LARDNER LLP;SUITE 500, 3000 K STREET NW, WASHINGTON, DC, 20007, US

(73) Assignee: Aberdeen Asset Management Asia Ltd.

(21) Appl. No.: 12/680,688

(22) PCT Filed: Oct. 3, 2008
(86) PCT No.: PCT/SG2008/000383

§ 371 Date: Mar. 29, 2010

(30) Foreign Application Priority Data
Dec. 27, 2007 (SG) 200719149-7

(51) Int. Cl. G06Q 40/00

(52) U.S. Cl. 705/35

(57) ABSTRACT

An apparatus for analysing securities data comprises a holdings module configured to determine, from the securities data, a value of a current holding in a security. The apparatus also comprises a disclosure determination module configured to determine, from a comparison of the value of a current holding with a rule stored in a database of disclosure rules, if the current holding is to be disclosed.

### FIELD OF THE INVENTION

The invention relates to apparatus and methods for analysing securities data. The disclosed techniques can be used to determine if a holding in a security is to be disclosed to, for example, a Stock Exchange, comply with disclosure rules.

### BACKGROUND TO THE INVENTION

Data analysis in the field of finance has become increasingly important. For data relating to securities such as stocks and stock options, data analysis is relied on primarily to enable an investor or potential investor to make an informed decision on their investment. As such, the analysis carried out is done to maximise financial gain from the securities. For instance, programs such as TradeStation Securities allow an investor to analyse historical securities data and to test an investment strategy before executing the strategy at a stock exchange.

More recently, advances have been made to automate data retrieval and analysis for keeping track of securities. For instance, Farrell Jr in US Patent Publication No. 2007/0129960 provides an example system and method for automated reporting of corporate actions such as announcements made by a corporation. Farrell Jr's system and method, which seek to reduce mistakes that lead to financial losses, is also directed at maximising financial gain from the securities.

The focus of securities data analysis to date has therefore been on maximising financial gain.

### SUMMARY OF THE INVENTION

The invention is defined in the independent claims. Some optional features of the invention are defined in the dependent claims.

By providing a disclosure determination module configured to determine whether a current holding in a security is to be disclosed by a comparison of a value of the securities data (e.g. the number of shares in the holding) with one or more rules stored in a database of disclosure rules, an investment managing entity (IME) is provided with the facility to monitor a multitude of investments in securities in plural locations—e.g. on plural stock exchanges—around the world, remote from one another and the IME, and identify automatically an investment position that needs to be disclosed to the stock exchanges.

Typically, an investment managing entity seeks to monitor and report on its rapidly-changing investments on a daily basis to meet disclosure obligations set by various stock exchanges. Also typically, when a position in a holding has been reached, the stock exchanges require the disclosure to be made within a pre-determined period, usually called a “compliance period”. The disclosure rules set by the stock exchanges are complex and constantly evolving and are applied to large securities datasets which are, themselves, of a complex nature. Monitoring of the securities datasets and the disclosure rules, and making an accurate and correct determination that a stock position is required to be disclosed to a stock exchange is an onerous task. Importing and storing in a database the disclosure rules of the stock exchanges may ease a burden on the investment managing entity. By configuring the disclosure determination module to determine whether a disclosure needs to be made by executing a comparison with the disclosure rules in the database the processing time required to identify an accurate and repeatable fashion the need to disclose can be reduced. Further, by coming to a determination that a disclosure must be made in such an efficient manner, the investment managing entity may be afforded additional time to file a disclosure before expiry of the prescribed compliance period. In one disclosed technique, the apparatus and method also allow processing time and errors to be reduced by importing a parameter relating to the current holding into a disclosure form or report responsive to a determination a disclosure must be made.

In the apparatus which provide a maintenance module, the investment managing entity also has the facility to import current data concerning securities data and/or stock exchange disclosure rules thereby obviating concerns that disclosure decisions are arrived at with reference to superseded disclosure rules and/or data.

An apparatus implementing features of the appended claims is able to:
Import shareholding information (securities data) on a regular basis
Analyse the securities data with reference to the disclosure rules stored in the database
Produce disclosure reports and forms as appropriate on a timely basis
Allow users to maintain the reports and rules.

### BRIEF DESCRIPTION OF THE FIGURES

Example embodiments of the apparatus and methods will now be described with reference to the accompanying figures in which:

FIG. 1 is a block diagram illustrating an architecture of an apparatus for analysing securities data,

FIG. 2 is a flow chart illustrating a technique for, analysing securities data,

FIG. 3 is a block diagram illustrating an architecture of the holdings module of the apparatus of FIG. 1,

FIG. 4 is a flow chart illustrating a technique for determining a current holding,

FIG. 5A is a flow chart illustrating a technique for determining if a disclosure is to be made,

FIG. 5B is a flow chart illustrating a technique for checking a subsequence rule and period, and

FIG. 6 is a block diagram illustrating an architecture of a system including the apparatus for analysing securities data.

### DETAILED DESCRIPTION OF EXAMPLE EMBODIMENTS

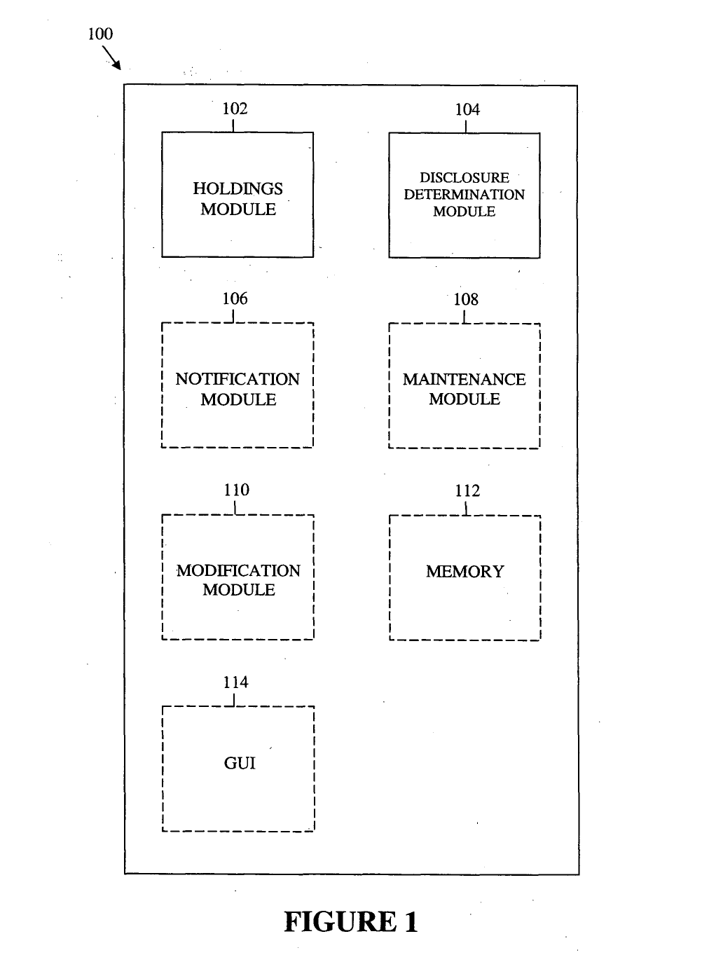

Referring to FIG. 1, an example apparatus 100 for analysing securities data is shown. The term ‘securities data’ as used in this specification refers to data that provides sufficient information for calculating an entity's holding in a security. Non-limiting examples of such data will be described under the heading ‘The Securities Data’ later in this specification.

The apparatus 100 principally comprises a holdings module 102 configured to determine, from the securities data, a current holding in a security, and a disclosure determination module 104 configured to determine, from a database of disclosure rules, if the current holding is to be disclosed. Detailed operations of the holdings module 102 and the disclosure determination module 104 will be described later in this specification.

Optionally, the apparatus 100 also comprises one or more of the following: a notification module 106, a maintenance module 108, a modification module 110, memory 112 and a graphical user interface (GUI) 114. The memory 112 may be used to store the securities data or the database of disclosure rules. The GUI 114 may be used by a user to enter data or commands into any one of the modules described above. The optional modules will be described in greater detail later in this specification.

In one example embodiment, the apparatus 100 is a computer apparatus which implements the modules above in hardware, for instance using individual or separate processors programmed to carry out the disclosed functions of the modules. In another example embodiment, one or more modules of the apparatus 100 could be implemented in software, as a series of instructions which, when executed by a processor or other computing device, perform the same function as the hardware embodiment described above or the method described below. A combination of hardware and software implementation may also be used. For instance, the apparatus 100 may be a hardware arrangement configured to read from a computer readable medium, or obtained from a network, executable code for implementing the disclosed method. The apparatus 100 may also be part of a system that is used to analyse securities data. An example system will be described later in this specification.

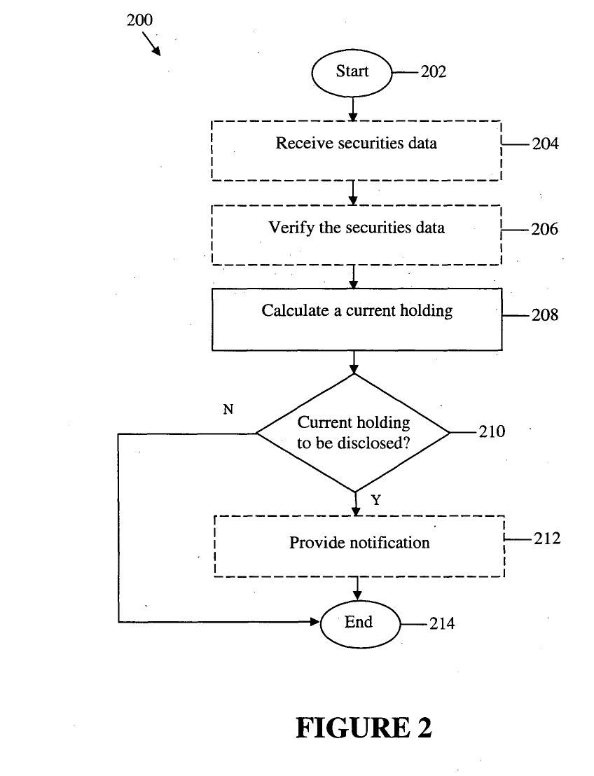

Referring now to FIG. 2, the process flow of an example method of analysing securities data is shown generally as 200. The process begins at step 202. At step 204, the holdings module 102 receives the securities data. The securities data may be received automatically from a database or may be input by a user using the GUI 114. It will be appreciated that step 204 is only optional as the securities data may have been previously received.

In step 206, the holdings module 102 verifies the securities data. In an example form, the holdings module 102 checks the arrangement of the securities data against a predefined data schema or by checking the substantive content of the data. This step is also optional as the data may have previously been verified or may have been received in a form that does not require verification.

In step 208, the holdings module 102 uses the securities data to calculate a current holding in a security. In step 210, the disclosure determination module 104 then determines, from a database of disclosure rules, if the current holding is to be disclosed. If the current holding does not need to be disclosed, the process ends at 214. If, on the other hand, the current holding should be disclosed, the process proceeds to step 212, where a notification of that fact is provided. Step 212 is, however, optional since the process may only be required to produce an answer to the determination in step 210.

An example of the application of the apparatus and method will now be described. It should be noted that the example is being provided solely to provide context for the subsequent detailed description and, as such, is not limiting.

### Example

Stock AAA has 100,000,000 shares outstanding in the market. Also, stock AAA has been registered at, amongst others, the Singapore Exchange Ltd (SGX), which has a rule requiring any fund manager acquiring 5% or more of any outstanding shares to disclose that fact by filing a predefined form at the SGX.

An investment managing entity (IME) has five funds (Fund A through E). As will be known to skilled persons, an IME is an entity that has been granted the power to dispose (i.e. buy and sell) and/or the power to vote in relation to securities on behalf of other entities. In this example, the IME has invested in stock AAA for each of the five funds that it manages as follows:
Fund A 1,900,000 shares (with power to vote)
Fund B 1,000,000 shares (with power to vote)
Fund C 1,000,000 shares (with power to vote)
Fund D 1,000,000 shares (with power to vote)
Fund E 1,000,000 shares (without power to vote)

IME therefore holds 5,900,000 shares but only 4,900,000 shares include voting rights (i.e. since Fund E covers shares without voting rights). This equates to a voting-rights holding of 4.9% of the total shares outstanding (4,900,000/100,000,000×100%).

The IME now purchases another 1,000,000 shares of stock AAA for Fund A. Using the apparatus or method disclosed, the IME will be able to determine automatically that the holding for stock AAA has changed from a previous holding of 4.9% to a current holding of 5.9%. The current holding of 5.9% can then be automatically compared to the disclosure rules of various stock exchanges, such as the 5% rule of the SGX noted earlier. From this comparison, the IME will be automatically alerted to the need to file a disclosure or a declaration at the SGX. In this specification, the terms ‘disclosure’ and ‘declaration’ are used interchangeably.

A detailed description of various aspects of the apparatus and method will now be described. As the details relate only to example embodiments, skilled persons will appreciate that the apparatus and method are not limited to those embodiments.

### The Securities Data

As noted earlier, the term ‘securities data’ refers to data that provides sufficient information for calculating an entity's holding in a security. The extent of the information required in the data will vary depending on the application. In one example, the data may include three types of data: fund data, holdings data and order data. Where required, a fourth type called extra orders data may be provided.

### Fund Data

Fund data, which reflect the details of an entity's fund, may be imported from a database held by the entity and be provided in the format shown in Table 1 below. In one form, the database is implemented using Lotus Notes and the fund data may be imported in the form of a CSV file. It will be appreciated that it is not essential for all of the fields noted in the table to be provided or, where provided, to be in the listed structure or form. For instance, where the method is used only by an individual investor, there may be no need to provide fund data if the investor's holding is not divided into different funds/groups. Skilled persons will appreciate that fund data is commonly provided where the entity using the apparatus and method is an investment managing entity, but may also be provided in other instances where needed or desired.

TABLE 1
Example structure of fund data

| No. | Field Name | Description | Data Type |
|---|---|---|---|
| 1 | Name | Fund Name | Char(100) |
| 2 | Code | Fund Code | Char(50) |
| 3 | Investment Manager | | Char(100) |
| 4 | Investment Advisor | | Char(100) |
| 5 | Sub-Investment Advisors | | Char(100) |
| 6 | Does managing entity have | | Char(3) |
| | voting rights for this fund? | | |
| 7 | Group | Is Segregated Fund? | |
| 8 | Custodian | Custodian Name | |
| 9 | Trade Date | | Date |

Referring to Table 1, the name field may be any chosen name for the fund, while the code field may be a HiPort or Charles River Development code for the fund. As will be known to skilled persons, Charles River Development provides a secure financial network having databases of holdings and orders that have been processed. The investment manager, advisor and sub-investment advisor fields denote the persons appointed by the entity as such. The voting rights field is provided to identify if the investment managing entity has the power to vote for the fund. The group field may be provided where the investment managing entity forms part of a larger group of investment managing entities. For instance, entity A may comprise entity A1 (e.g. a Singapore branch) and entity A2 (e.g. a UK branch). If the investment managing entity does form part of a group, it may be necessary to indicate whether the fund is segregated to the individual investment managing entities (i.e. A1 and A2) or is shared among the investment managing entities in the group. The custodian field may indicate the custodian with which the shareholder has a custody agreement, and the trade date field may indicate the date of the last trade that was made in relation to that fund.

### Holdings Data

Holdings data, which reflect the details of an entity's holding in a security, may be imported from a Charles River Development database or any other suitable database and be provided in the format shown in Table 2 below. The holdings data may be in Microsoft Excel format, for example. As before, it is not essential for all of the fields noted in the table to be provided. Where desired or necessary, fields may be added, deleted or modified to suit a particular application.

TABLE 2
Example structure of holdings data

| No. | Field Name | Description | Data Type |
|---|---|---|---|
| 1 | Trade Date | | Date |
| 2 | Account Code | Fund Code | Char(50) |
| 3 | Account Name | Fund Name | Char(100) |
| 2 | SEDOL | | Char(50) |
| 3 | Security Description | | Char(100) |
| 4 | Asian Stock? | | Y/N |
| 5 | Country of Issue | | Char(3) |
| 6 | Investment | | Char(10) |
| | Classification Name | | |
| 7 | Quantity | Current Holding | Number (Double) |
| 8 | Quantity Outstanding | Outstanding Shares | Number (Double) |
| 9 | Industry Group Code | For Bank, Diversified | |
| | | Financials | |
| 10 | Stock Exchange Name | | |
| 11 | Ticker | | |

In the table above, the trade date field is used to identify the last date on which the holding of a particular security was last dealt with. The account code and name fields are similar to the code and name fields of the fund data. The SEDOL field may be populated with the security's identifier from the Stock Exchange Daily Official List. The security description field provides a description for the security, while the Asian stock field provides an indication of whether the stock is based in Asia or not. The latter field may be omitted altogether and reliance may be placed on the country-of-issue field instead. The investment classification field may be used to indicate the type of security being represented (e.g. equity, bond, debenture, etc). The quantity field reflects the entity's current holding in the security, while the quantity outstanding field reflects the total outstanding shares that were issued by the security. The industry group code field may be used to represent the industry type (e.g. Bank and Finance etc.). The stock exchange name field and ticker field respectively indicate the stock exchange at which the security is registered and the ticker symbol of the security.

### Orders Data

Orders data, which reflect details of an order that has been executed in relation to the entity's holding, may be imported from a Charles River Development database and be provided in the format shown in Table 3 below. As before, it is not essential for all of the fields noted in the table to be provided. Where desired or necessary, fields may be added, deleted or modified to suit a particular application.

TABLE 3
Example structure of orders data

| No. | Field Name | Description | Data Type |
|---|---|---|---|
| 1 | Fund Code | | Char(50) |
| 2 | SEDOL | | Char(50) |
| 3 | Trade Date | | Date |
| 4 | Transaction Type | | Char(10) |
| 5 | Security Name | | Char(100) |
| 6 | Quantity | | Number (Double) |
| 7 | Price | | Number (Double) |
| 8 | Order ID | | Char(10) |

In the table above, the fund code field is similar to the code field of the fund data. The SEDOL field and trade date fields are as noted earlier, but this time for the security identifier and date for the particular order that has been executed. The transaction type field would reflect transactions such as a ‘buy’ or a ‘sell’. The remaining fields provide other details of the security and the transaction.

### Extra Orders Data

The extra orders data are data that are used to represent a take-on or withdrawal in relation to a fund. Specifically, ‘take-on’ refers to the taking-on of assets in the form of securities from clients and ‘withdrawal’ means the withdrawal of assets in the form of securities by existing clients. Where such ‘take-on’ or ‘withdrawal’ situations exist, the extra orders data are used to ensure the securities data accurately reflect the present security position. The data itself may be provided in the format identical to the orders data in Table 3.

For each of the data types above that include SEDOL data, one further improvement may be to provide a manual data entry facility that allows the entry and storing of additional SEDOL data that are not stored in the Charles River Development databases. For instance, the additional SEDOL data may include the International Standard Identification Number (ISIN), the PAR number (the face value of the security) and an industry code override.

### The Holdings Module

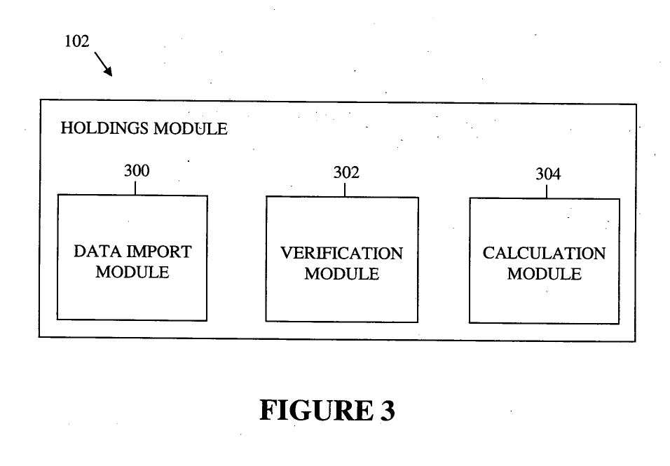

As described earlier, the holdings module 102 of the apparatus 100 is configured to determine, from the securities data, a current holding in a security. In one example form, as shown in FIG. 3, the holdings module 102 includes three modules (or sub-modules): a data import module 300, verification module 302 and calculation module 304. It is not essential for the modules to be part of the holdings module 102, however. Where necessary or desired, the three modules may be arranged as independent modules or may form part of other modules in the apparatus 100.

### The Data Import Module

The data import module 300 serves to provide the data that is received in step 204 of FIG. 2. In one form, the data import module 300 imports the securities data in the form of fund data, holdings data and orders data as described earlier. As before, the data may be imported by the data import module 300 from external databases such as that provided by Charles River Development or an internal database of the entity. In one form, the database may be provided in the apparatus 100 itself (e.g. in memory 112). The data import module 300 may also receive the data from a user via the GUI 114. In one form, the data import module 300 receives the securities data on a daily basis.

An example process of a user using the data import module 300 will now be described. The process begins with a user importing data into the holdings module 102 using the data import module 300. The data import module 300 responds by displaying to the user a screen for data importing. The user selects a data type (e.g. from a drop-down list) from the security data types (e.g. Fund, Holding, Order and Extra Order). The Fund data is preferably the first data to be imported. Preferably, the data import module 300 checks if the Fund data has been imported before allowing other data types to be imported.

Once imported, the user previews the data to check for accuracy. Following this, the data import module 300 sends the data to the verification module 302 to verify the data against a stored data schema and to check if the new data is a duplicate of data already stored in the data import module 300. If the data imported does not match the data schema, the data import module 300 alerts the user to this. Where the imported data is either Holding or Order data, the data import module 300 checks the fund date of the data against the fund date of Fund data already imported. If the dates do not match, the user is notified of this by the data import module 300. The data import module 300 also checks if disclosures for the particular date have already been submitted to the relevant stock exchange. This may be done by checking the notification module 106 to see if a notification has already been submitted. If so, the user may be prevented from using the data import module 300 to repeat the determination process for the same date. Otherwise, if the need to disclose has not been determined, or if the need to disclose has been determined but a disclosure has not yet been submitted, the user is prompted by the data import module 300 to confirm that the data to be imported should override the existing data.

The data import module 300 operates—whether with or without a display generator (not shown)—to display the imported data on a screen, allowing the user to check the data and confirm the importing of the data into the data import module 300. The user then repeats the above steps to import other data types, as appropriate. Once the data import module 300 has completed the importation of the Fund, Holding and Order data, the previous version of such data that are stored in the data import module 300 is deleted. Where Extra Order data is imported, the extra order represented by the data is appended to the data already imported (e.g. the Order data). Once completed, the user may use the verification module 302 to further verify the data imported.

### The Verification Module

The verification module 302 serves to verify the accuracy of the data imported by data import module 300. This verification step is shown as step 206 in FIG. 2.

In one embodiment, as described earlier with reference to the data import module 300, the verification module 302 is configured to verify the form of the data. For instance, the verification module 302 verifies that the data imported is not a duplicate of data previously imported. Alternatively or additionally, the verification module 302 may verify that the data has been imported in a pre-determined order (e.g. fund data first, followed by holdings data, then order data), or that the data imported meets with a Specified data schema (e.g. the schema presented in Tables 1-3).

In one embodiment, the verification module 302 verifies the substantive content of the data. For instance, the verification module 302 may extract and reconcile, based on the securities data, the current holding with an indication of what the current holding should be. To do this, the verification module 302 may be configured to determine the entity's previous holding (i.e. holding as of the previous day) and current holding (i.e. holding as of the current day). The previous holding (PrevHold) and the current holding (CurHold) for the purposes of verification may be imported from a database such as that provided by Charles River Development. The verification module 302 may also be configured to calculate, from the securities data, a change in holding in the security. For instance, for each SEDOL code and Fund Code listed in the orders data, the module calculates a total ‘buy’ quantity (QBuy) and a total ‘sell’ quantity (QSell). A daily change (QChg) is then determined by QChg=QBuy−QSell. The verification module 302 then determines if a sum of the previous holding and the change in holding is equivalent to the current holding. In mathematical terms, the determination is whether ((PrevHold)+(QChg))=CurHold. If the result is positive, the data is confirmed as having been verified. Otherwise, an error may be present and, optionally, an error message generated.

### The Calculation Module

The calculation module 304 serves to calculate the current holding from the securities data, as in step 208 in FIG. 2.

The exact calculations that are made are dependent on the investment managing entity using the apparatus or method, and the types of disclosure that need to be made. The detailed description that follows is suited particularly for an international investment management group comprising several investment managing entities in different jurisdictions.

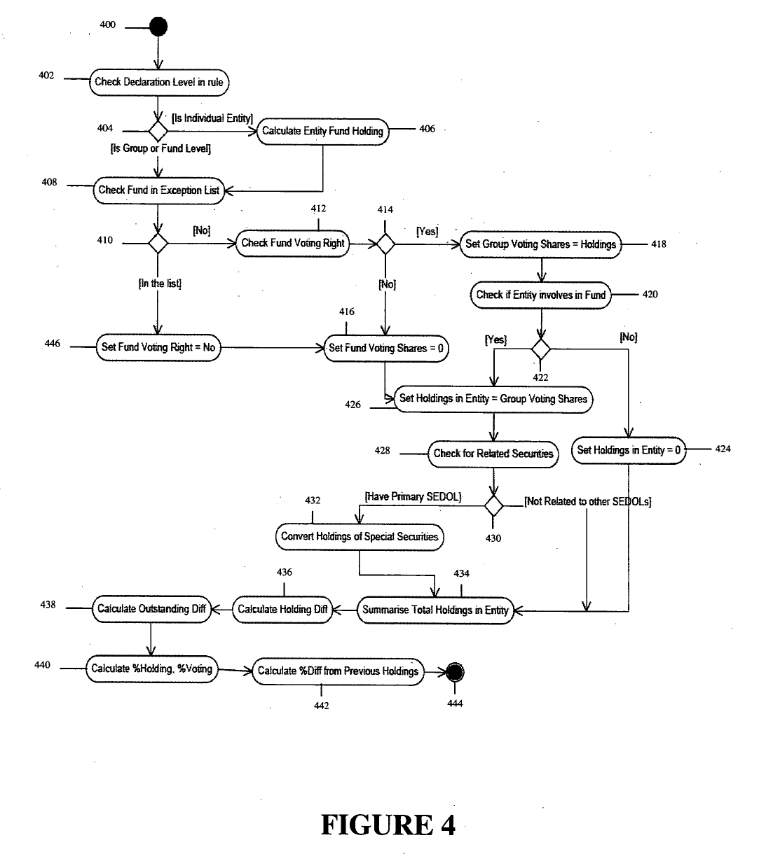

A flow chart of operations carried out by one embodiment of the calculation module 304 is shown in FIG. 4. The process starts at 400. In step 402, the declaration level that is specified in the rules is checked. In one form, each rule may specify one of three levels: group, fund or individual. The use of these levels will be explained below with reference to an example.

Assume that investment managing entity A has subsidiaries A1 and A2. In other words, Group A comprises entities A, A1 and A2.

Each of A, A1 and A2 have invested in stock AAA in the following funds:

| Entity | Fund Name | Holding |
|---|---|---|
| A | Fund 1 | 3% in stock AAA |
| | Fund 2 | 1% in stock AAA |
| A1 | Fund 1 | 3% in stock AAA |
| A2 | Fund 3 | 6% in stock AAA |

Assume also that one exemplary disclosure rule in the database of disclosure rules requires a disclosure to be made if a holding at a certain disclosure level exceeds 5%. The holdings module 102 determines, from the exemplary disclosure rule, a disclosure level at which the current holding is to be disclosed: group, fund or individual, and makes a determination of the current holding at the disclosure level. If, say, the rule only requires disclosures at an individual level, the holdings module 102 determines that a disclosure only needs to be made for A2 in relation to Fund 3 (as A2 is the only individual entity with holding over 5%). If the rule requires disclosures at a group or fund level, holdings module 102 determines that a disclosure needs to be made for Group A in relation to Fund 3 (as entity A2 of Group A holds 6% in stock AAA) and Fund 1 (as the total holding for A and A1 in Fund 1 exceeds 5%).

To take the above into account, a determination is made at step 404 to determine the level for which the disclosure is to be made specified by the rule. If the rule specifies an individual level, each individual entity's holding in a particular fund is determined at step 406. The method then proceeds to step 408 to check if the fund (and the security's identifier) is in an exception list. The funds defined in the exception list belong to private clients group and are excluded from the calculation. Where the rule specifies a group or fund level, the method proceeds directly to step 408.

If, from a determination made in step 410, the fund is not found to be in the exception list, the method proceeds to step 412 to check the voting rights in the fund. A determination is made in step 414 as to whether the entity has voting rights for the particular fund. If the determination is negative, the process proceeds to step 416 to set to zero a parameter called Fund Voting Shares. Otherwise, the method proceeds to step 418 to set a parameter called Group Voting Shares to be the amount of holding for which the entity has voting rights. In this form, the Group Voting Shares is a parameter that is used for securities calculation; the parameter Fund Voting Shares is a flag used to note those funds that are in the exception list or that have or do not have voting rights.

In step 420, the method checks to see if the entity is involved in the fund in any one of the following roles: Investment Manager, Investment Advisor or Sub-Investment Advisor. If a determination in step 422 reveals that the entity is not so involved, a Holdings in Entity parameter is set to zero in step 424 to reflect the entity's lack of involvement. Otherwise, if the entity is involved, the method proceeds to step 426 to set the Holdings in Entity as the Group Voting Shares as previously determined in step 418.

In step 428, the method checks to see if the security (for which the rules are being checked) is listed in a related securities list. A related security is a security that is related to the primary security. Examples include depositary receipts, such as American Depository Receipts (ADR) and Global Depository Receipts (GDR). If, following a determination in step 430, the security is found to have a primary security, the holdings module 102 determines if the security has a related security and converts the current holding based on a conversion factor of the related security. In the described implementation, the Holdings in Entity previously determined is converted in step 432 using the formula: Converted Holdings in Entity=Holdings in Entity×Conversion Factor of Related Security. The Conversion Factor is a value defined by the owner of the related and primary security.

The method then proceeds to step 434 to determine the Total Holdings in Entity. To do this, the holding for each security in all funds are summed. The method then calculates in step 436 a holding difference as follows: Holdings Difference=Current Holdings−Previous Holdings.

In step 438, a difference in outstanding shares is calculated as follows: Outstanding Difference=Current Outstanding−Previous Outstanding. In step 440, a Percentage Holding and a Percentage Voting are calculated by respectively dividing the total holding and total voting shares (reflected by the Group Voting Shares) with the total outstanding shares. The Percentage Voting is calculated for declarations that are based on value of percentage voting in relation to the security.

A Percentage Holding Difference is then calculated in step 442 as follows: Percentage Holding Difference=Current Percentage Holdings−Previous Percentage Holdings. The Current Percentage Holdings is determined using the formula ((Current Holdings/Current Outstanding)×100), while the Previous Percentage Holdings is determined using the formula ((Previous Holdings/Previous Outstanding)×100). Once values for these parameters are calculated, the method ends at 444.

Going back to the determination made in step 410, if the fund is found in the exception list, the method proceeds to step 446 to set a parameter called Fund Voting Right to ‘no’. In step 416, the method sets another parameter Fund Voting Shares to zero. By setting these parameters, the method may continue with steps 426 onwards and at the same time disregard the fund which was found in the exception list.

The calculation module 304 may also allow a user or administrator to carry out an enquiry as to the historical trades of a particular security, preferably together with its related securities. For instance, an administrator may input a particular SEDOL (Stock Exchange Daily Official List) identifier into the calculation module 304, and the calculation module 304 may output a table or report showing historical trade information (e.g. fund code, fund name, trade date, order type, quantity, price etc) for that SEDOL identifier.

The detailed description above includes steps that particularly cater for the different disclosure requirements of different jurisdictions and for a large investment managing entity with subsidiaries. Where used for different entities or purposes, some of the steps described in the detailed description above may be omitted or modified to suit. For instance, for an individual entity with no affiliated group, the group level checking steps may be omitted altogether. Also, where the disclosure rules require disclosure of holding regardless of voting rights, the voting rights checking steps may be omitted. These changes are exemplary and skilled persons will appreciate that other changes may be made instead or in addition to the ones mentioned above.

### The Disclosure Determination Module

As described earlier, the disclosure determination module 104 is configured to determine, from a database of disclosure rules, if the current holding is to be disclosed. The database of disclosure rules may be provided internally in the apparatus 100 or may be a database remote from the apparatus 100. The database is preferably provided with details of disclosure rules set by a plurality of stock exchanges. Example disclosure rules that may be stored in the database are noted in Table 4 below:

TABLE 4
Example Database of Disclosure Rules

| | Stock | | Trigger Range | | |
|---|---|---|---|---|---|
| No. | Exchange | Rule Type | Trigger | Min | Max |
| 1 | SGX | Initial >= | 5% | | |
| | (Singapore) | Subsequent on Percent | | 5% | 100% |
| | | Level Change | | | |
| | | Cessation < | 5% | | |
| 2 | ASX | Initial >= | 5% | | |
| | (Australia) | Subsequent on change | 1% | 5% | 100% |
| | | from last declaration +/− | | | |
| | | Cessation < | 5% | | |
| 3 | Jap NSE | Initial >= | 5% | | |
| | (Japan) | Subsequent on change | 1% | 5% | 100% |
| | | from last declaration +/− | | | |
| | | Cessation on change | 1% | | 5% |
| | | from last declaration +/− | | | |
| | | Subsequent when reach | 10% | | |

Taking the SGX as an example, three types of rules are stored. The Initial Rule specifies the disclosure requirement where an entity exceeds a holding threshold for the first time (i.e. where no holdings disclosure or declaration was previously made). The Subsequence Rule specifies the disclosure requirement where the entity has previously made a holdings declaration, but is again found to hold more than a threshold amount. The Cessation Rule specifies the disclosure requirement where the entity has previously made a holdings declaration, but is now found to hold less than a threshold amount. For each rule type, a Period field (not shown) is also provided to specify the period within which a disclosure must be made if the respective rule is met.

It will be appreciated that the disclosure rules need not be restricted to those set by stock exchanges. A disclosure rule may also be one that is set by the company. For instance, a company may wish to be informed if their holdings exceed 3%, even though stock exchanges only set a disclosure threshold of 5%. In such instances, a company-only disclosure rule may be set at 3%.

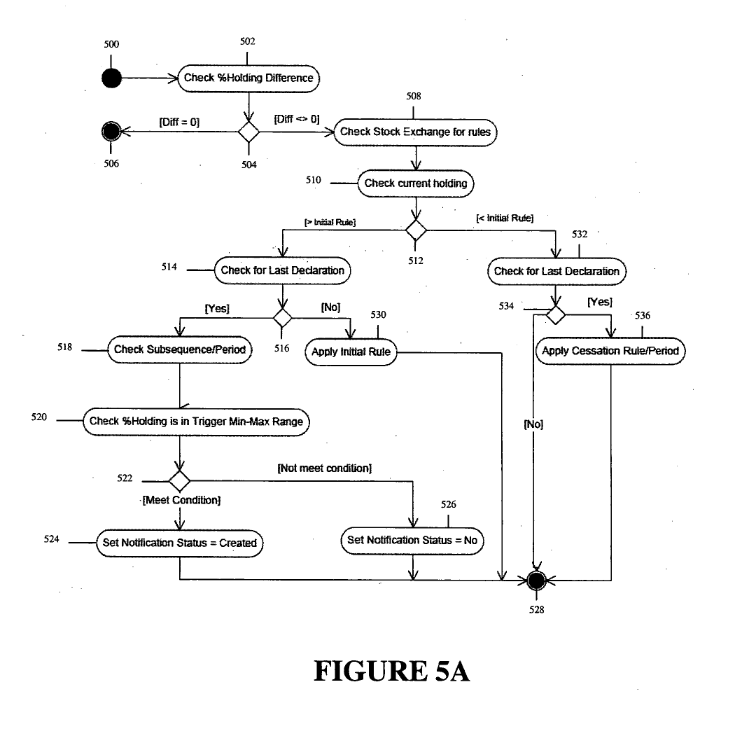

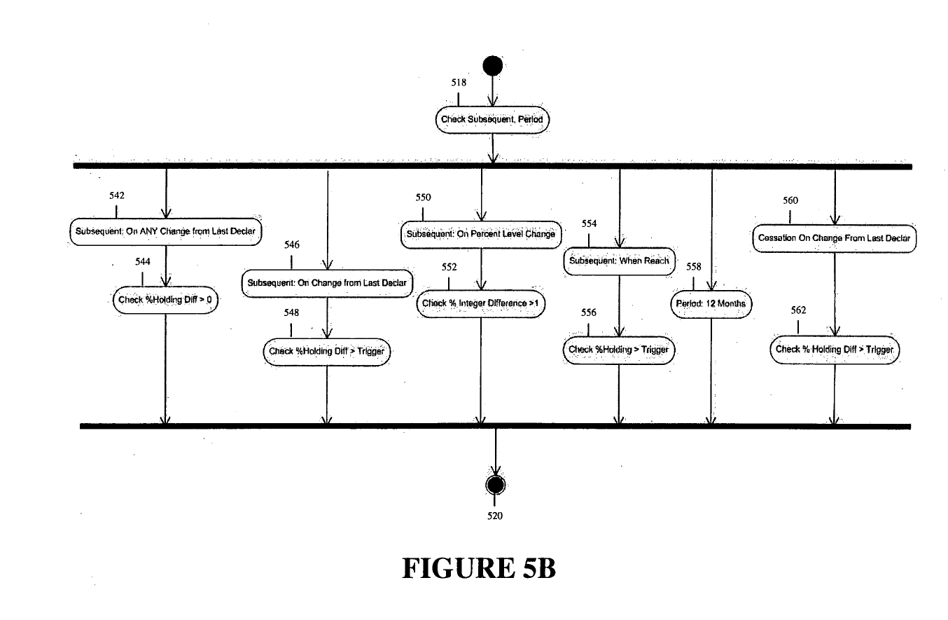

An example process flow for the disclosure determination module 104 is shown in FIG. 5A. As before, the detailed description that follows is suited particularly for an international investment management group comprising several entities in different jurisdictions. Accordingly, the steps described below may be modified to suit different entities or purposes.

The example process flow for the disclosure determination module 104 begins at 500, which is a continuation from the end 444 of the process flow of the calculation module 304 in FIG. 4. In step 502, the percentage holding difference is checked. If, from a determination in step 504, the percentage holding difference is found to be zero, the method ends at 506. If the percentage holding difference is non-zero, the method proceeds to step 508 to check the disclosure rules from various stock exchanges. In one form, the method checks the disclosure rules database (see Table 4), which includes disclosure rules that have been coded/stored in the database, and which are updated regularly (e.g. quarterly). Where desired or necessary, these steps may be omitted altogether and disclosure determination module 104 proceeds directly to step 510. Thus, the disclosure determination module is configured to determine if the current holding exceeds the threshold value only if the percentage holding difference is non-zero Also, in some cases, it may be desired to produce a notification as soon as it is determined from step 508 that there is a need for disclosure. For a more detailed assessment of the change in holding and rules, however, the steps below may be carried out.

In step 510, the process checks the entity's current holding of the security. The entity's current holding is the current holding as determined by the holdings module 102. If, from a determination in step 512, it is found that the current holding is more than an Initial Percentage Holding as set out in the rule determined from step 508, the method proceeds to step 514 to check if a declaration had been previously made. If, from a determination in step 516 it is found that there was a declaration made previously, the Subsequence Rule and Period of the rule are checked in step 518. A detailed description of this checking step will be described below with reference to FIG. 5B.

Once the checking in step 518 is complete, a check and determination is then made in steps 520 and 522 to determine if change in holding meets a trigger range as set in the rule. If conditions set in the rule are met, an indication is provided at step 524. In the form shown, the indication is a Notification Status that is set to ‘Created’, which may indicate that a notification has been generated. If the determination in step 522 is negative, the Notification Status is set to ‘No’ in step 526. Skilled persons will appreciate that other forms of indications, such as a flag indicating that a disclosure is required, may be used instead. The process of FIG. 5A then ends at 528.

Where the determination in step 516 of whether a previous declaration had been made is negative, the method proceeds to step 530 where an Initial Rule as specified by the stock exchange is applied.

Where the determination in step 512 reveals that the current holding is less than an Initial Percentage Holding, steps 532 and 534 are carried out to check if there had been a declaration made previously. If a declaration had not been made previously (e.g. the entity did not previously hold more than 5%), no declarations need to be made now and, as such, the method ends at 528. If a declaration had been made previously (e.g. declaring that the entity previously held more than 5%), the Cessation Rule and Period of the rules will be checked (similar to step 518) and applied in step 536.

Referring now to FIG. 5B, details of the Subsequence Rule and Period checking will now be described. The process starts at step 518 and ends with step 520 as in FIG. 5A. A similar checking is also done in step 536 as noted above. In essence, the checking is as follows:
1. Subsequent: On any change from last declaration (step 542), step 544 will check that ‘% Holding Diff’ is greater than 0.
2. Subsequent: On change from last declaration (step 546), step 548 will check that ‘% Holding Diff’ is greater than the trigger that is defined in the rules.
3. Subsequent: On percent level change (step 550), step 552 will verify that the ‘% Integer Difference’ is greater than 1%.
4. Subsequent: When reach (step 554 and as defined in Table 4), step 556 will check whether ‘% Holding’ is greater than the trigger that is defined in the rules.
5. Period: This is defined as 12 Months in step 558 as some stock exchanges require declarations of holdings to be made per annum.
6. Cessation: On change from last declaration (step 560), step 562 will check that ‘% Holding Diff’ is greater than the trigger that is defined in the rules.

It may be that the determinations above result in duplicate or multiple rules being triggered. For instance, assuming there is Rule A for disclosure at 5% and Rule B for disclosure at 10%, and assuming the company's holding increases from 4% to 11%, both Rules A and B will be triggered. Depending on the circumstances and the obligations on the company, it may only be necessary to produce a single notification following Rule B, rather than two notifications following both Rules A and B. To do this, the disclosure determination module may be provided with precedence relating to which rule trumps other rules in the event duplicate or multiple rules are triggered. Referring to FIGS. 5A and 5B, one non-limiting precedence list (i.e. the higher the rule ranking, the greater its precedence) is as follows:
1. Initial
2. Cessation
3. When Reach
4. Subsequent on Percent Level Change/Subsequent on Change/Subsequent on Any Change

Precedence of one rule over others may also depend on the rule's generality. If, for instance, Rule A applies to all industry codes, and Rule B applies to a specific code, it may be preferable to choose a disclosure based on Rule B and not Rule A for that specific code. If, on the other hand, both rules have specific and identical industry codes, it may be preferable to allow disclosures based on both rules to be generated.

### The Notification Module

The notification module 106, where used, may be configured, responsive to the disclosure determination module determining that the current holding is to be disclosed, to import a parameter relating to the holding into a form or report. That is, the notification module 106 is configured to receive indications from the disclosure determination module 104 as to whether a disclosure is to be made. If a disclosure is to be made, the notification module 106 outputs one or more notifications or indications that have been generated by the disclosure determination module 104.

The notification or indication generated by the notification module 106 may be a simple indication such as a flag of ‘yes’ or ‘no’ as to the need to submit a disclosure to the relevant stock exchange. In one implementation, the notification module 106 imports a parameter relating to the current holding to be disclosed into a form or report. A part of the form/report such as a cell or field is automatically populated with information extracted from the securities data or from the determinations made by the holdings module 102 (e.g. the current holding) and disclosure determination module 104 (e.g. if a disclosure was previously filed).

As an example, the notification may be a report stating ‘Dear Sir, We are writing to notify that accounts managed or advised by us now hold a total of X shares (Y %) in AAA. This follows a purchase of Z shares on [date of purchase]’. The notification module 106 may be configured to import a parameter relating to the current holding (such as the current holding X, the percentage holding Y, orders made Z and the security name AAA in the example above) automatically in a dynamic form or report. The forms or reports may then be submitted manually or, where possible, submitted online to the relevant stock exchange, a nominated person (such as a company secretary) or the like.

The notification module 106 may also be used to notify a user of information requested by the user. For instance, a user may enquire the day's changes in holding, notifications that need to be made, fund information, or reports that have been generated.

It is also envisaged that the notification module 106 may need to allow manual notifications to be generated. That is to say, rather than automatically importing data from the disclosure determination module 104, the notification module 106 may have a manual setting that allows a user or administrator to manually enter the data for disclosure (e.g. total holdings, percentage held, voting rights held etc).

### The Maintenance Module

The maintenance module 108, where used, may allow information used by the apparatus and method to be updated by adding, deleting or editing details. For instance, the securities data (such as the related securities list checked by the disclosure determination module 104) or the disclosure rules may be updated with the latest rules and securities. In one form, a user may use the module to manually upload the latest rules and securities. In another form, the latest rules and securities may be downloaded automatically from a server. Additionally, the stock exchanges that the apparatus 100 monitors may be updated (e.g. adding the New York Stock Exchange (NYSE) by adding the relevant rules and conditions set by the NYSE into the database of disclosure rules). Preferably, upon receiving a relevant update, the maintenance module 108 instructs the disclosure determination module 104 to determine if a disclosure is to be made in view of the update.

The forms, or reports used by the notification module 106 may also be updated using the maintenance module 108. The update may be done manually by a user or be downloaded automatically from a server. This allows the apparatus 100 to cater for future changes in report format or disclosure requirements from stock exchanges. Also, the maintenance module 108 may allow changes to be made to how disclosure rules are mapped or referenced to forms or reports (e.g. rule A is referenced to form AB and report AC, so if rule A is triggered, form AB and report AC are generated).

Other information that may be updated by the maintenance module 108 include: user access privileges (e.g. username, group, etc), group structure of the entity (e.g. parent company name, holding percentage, etc), company information (e.g. company name, secretary email address, etc) and exception lists. For instance, a user or administrator may update the exception list used in step 408 of FIG. 4 using the maintenance module 108.

### The Modification Module

The modification module 110, where used, may allow one or more modifications to be made by a user to the current holding as represented by the securities data. This module may be used in case the holding of any fund is found to be incorrect and a manual amendment is deemed necessary.

### The System

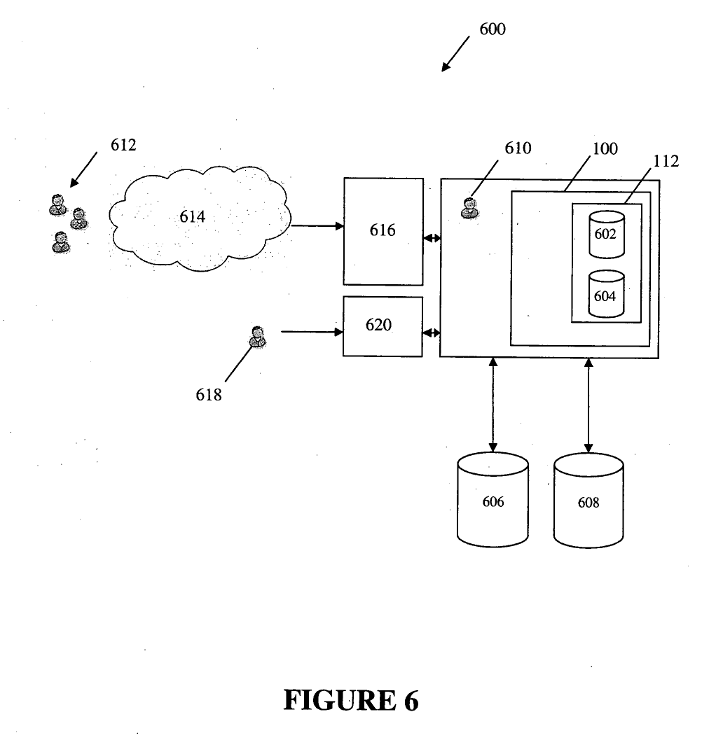

FIG. 6 shows an overview of an example system that includes the apparatus 100. In the form shown, the apparatus 100 includes two databases 602 and 604 in memory 112. Database 602 may store disclosure rules while database 604 may store disclosure forms or reports. As described earlier, the forms or reports may be automatically filled with one or more required details by the notification module 106 of apparatus 100.

Also as described earlier, the apparatus 100 may retrieve information from external databases. In the embodiment shown in FIG. 6, two external databases 606 and 608 are used. Database 606 may be a Charles River Development database, which includes information on orders for new or transferred funds, orders made, current holdings and outstanding shares for a plurality of securities. Database 608 may be a database of the funds held by the entity.

The apparatus may be provided as an intranet-based application that is accessible only to users, such as user 610, that are located at the entity's premises and that are able to access the entity's intranet. Such users may access the apparatus 100 without having to undergo any specific authentication procedure. Alternatively or additionally, the apparatus may be provided as an internet-based application for access by users 612 via the internet 614. In this form, the users 612 are preferably required to submit valid authentication details to an authentication module 616 before being able to access the apparatus 100. Where necessary or desired, the authentication module 616 may form part of the apparatus 100.

The apparatus 100 may also be accessed by an administrator 618 via an administrative module 620. The administrator 618, once authenticated by the administrative module 620, may use the maintenance module 108 to update data in the databases 602 and 604, or to update user permission information used by the authentication module 616. The administrator 618 may also use the modification module 110 to make any required modifications to the securities data analysed by the apparatus 100.

The foregoing describes exemplary embodiments, which, as will be understood by those skilled in the art, may be subject to many variations or modifications in design, construction or operation without departing from the spirit and scope of the present invention as claimed. For example, while the method has been described with reference to steps to be carried out in a certain order, the method may be modified such that the steps are carried out in a different order, where appropriate. Also, the method may be modified such that additional steps are carried out. Such variations, for instance, are intended to be covered by the scope of the present invention as claimed.

1.-25. (canceled)

26. An apparatus for analysing securities data comprising:
a holdings module configured to
determine, from a rule in a database of disclosure rules, a disclosure level at which a current holding in a security is to be disclosed, and
determine, from the securities data, a value of the current holding in the security at the determined disclosure level, and
a disclosure determination module configured to determine, from a comparison of the value of the current holding with the rule, if the current holding is to be disclosed.

27. The apparatus of claim 26 further comprising a notification module configured, responsive to a determination by the disclosure determination module that the current holding is to be disclosed, to import a parameter relating to the current holding into a form or report.

28. The apparatus of claim 26 wherein the holdings module is configured to determine the current holding based on holdings that include voting rights as determined from the securities data.

29. The apparatus of claim 26 wherein the holdings module is configured to determine if the security has a related security, and to determine the current holding based on a conversion factor of the related security.

30. The apparatus of claim 26 wherein the holdings module is configured to:
determine a current number of outstanding shares for the security, and
determine the current holding as a percentage based on the current number of outstanding shares.

31. The apparatus of claim 30 wherein the disclosure determination module is configured to:
determine if the current holding exceeds a threshold value defined by one or more of the disclosure rules, and
determine if a disclosure was previously made.

32. The apparatus of claim 31 wherein the holdings module is configured to:
determine a previous holding and a previous number of outstanding shares for the security,
calculate a current percentage holding based on the current holding and the current number of outstanding shares,
calculate a previous percentage holding based on the previous holding and the previous number of outstanding shares, and
calculate a percentage holding difference by determining a difference between the previous percentage holding and the current percentage holding.

33. The apparatus of claim 32 wherein the disclosure determination module is configured to determine if the current holding exceeds the threshold value if the percentage holding difference is non-zero.

34. The apparatus of claim 32 further comprising a verification module configured to:
calculate, from the securities data, a change in holding in the security, and
determine if a sum of the previous holding and the change in holding is equivalent to the current holding.

35. The apparatus of claim 26 wherein the apparatus further comprises a modification module configured to receive one or more modifications to the current holding.

36. The apparatus of claim 26 further comprising a maintenance module configured to update the securities data or the disclosure rules.

37. A computer-implemented method of analysing securities data using a processor in communication with a database of disclosure rules, the method comprising:
determining, from a rule in the database of disclosure rules, a disclosure level at which a current holding in a security is to be disclosed,
determining, from the securities data, a value of the current holding in the security at the determined disclosure level, and
determining, from a comparison of the value of the current holding with the rule, if the current holding is to be disclosed.

38. The computer-implemented method of claim 37 further comprising, responsive to determining that the current holding is to be disclosed, importing a parameter relating to the holding into a form or report.

39. The computer-implemented method of claim 37 wherein determining the current holding comprises determining the current holding based on holdings that includes voting rights as determined from the securities data.

40. The computer-implemented method of claim 37 wherein determining the current holding comprises determining if the security has a related security, and determining the current holding based on a conversion factor of the related security.

41. The computer-implemented method of claim 37 wherein determining the current holding comprises:
determining a current number of outstanding shares for the security, and
determining the current holding as a percentage based on the current number of outstanding shares.

42. The computer-implemented method of claim 41 wherein determining if the current holding is to be disclosed comprises:
determining if the current holding exceeds a threshold value defined by one or more of the disclosure rules, and
determining if a disclosure was previously made.

43. The computer-implemented method of claim 42 wherein determining the current holding comprises:
determining a previous holding and a previous number of outstanding shares for the security,
calculating a current percentage holding based on the current holding and the current number of outstanding shares,
calculating a previous percentage holding based on the previous holding and the previous number of outstanding shares, and
calculating a percentage holding difference by determining a difference between the previous percentage holding and the current percentage holding.

44. The computer-implemented method of claim 43 wherein the step of determining if the current holding exceeds the threshold value is carried out if the percentage holding difference is non-zero.

45. The computer-implemented method of claim 43 further comprising:
calculating, from the securities data, a change in holding in the security, and
determining if a sum of the previous holding and the change in holding is equivalent to the current holding.

46. The computer-implemented method of claim 37 further comprising receiving one or more modifications to the current holding.

47. The computer-implemented method of claim 37 further comprising updating the securities data or the disclosure rules.

48. A computer-readable medium having computer-readable instructions stored thereon for execution by a processor of the method of claim 37.
